(19) United States
(12) Patent Application Publication
(10) Pub. No.: US 2011/0154489 A1
(43) Pub. Date: Jun. 23, 2011

(54) SYSTEM FOR ANALYZING MALICIOUS BOTNET ACTIVITY IN REAL TIME

(76) Inventors: Hyun Cheol Jeong, Seoul (KR); Chae Tae Im, Seoul (KR); Seung Goo Ji, Gyeonggi-do (KR); Joo Hyung Oh, Seoul (KR); Dong Wan Kang, Seoul (KR)

(21) Appl. No.: 12/821,576

(22) Filed: Jun. 23, 2010

(30) Foreign Application Priority Data
Dec. 21, 2009 (KR) 10-2009-0127921

(51) Int. Cl. G06F 21/00

(52) U.S. Cl. 726/22

(57) ABSTRACT

A system for analyzing malicious botnet activity in real time is disclosed. This system may include: a control server configured to generate botnet activity information relating to a type of malicious botnet activity, and transmit the botnet activity information to the outside, after receiving bot occurrence information from the outside;

and a bot executing server configured to execute a malicious bot corresponding to the bot occurrence information received from the outside in a virtual environment operating system and transmit a real-time botnet detection result to the control server for generating the botnet activity information, according to a control of the control server, wherein the real-time botnet detection result includes information on whether or not the malicious bot performs malicious activity based on a command from a remote command/control server existing independently outside.

### CROSS-REFERENCE TO RELATED APPLICATIONS

This application claims the benefit of Korean Patent Application No. 10-2009-0127921, filed with the Korean Intellectual Property Office on Dec. 21, 2009, the disclosure of which is incorporated herein by reference in its entirety.

### BACKGROUND

1. Technical Field

The present invention relates to a system for analyzing malicious botnet activity in real time. More particularly, the invention relates to an analysis system for detecting malicious botnet activity involving malicious bots by hooking and analyzing API calls executed from a virtual environment to analyze the commands of the remote command/control server controlling the malicious bots and by analyzing the traffic transmitted by the malicious bots from the virtual environment to the outside.

2. Description of the Related Art

In general, a bot is a child process operating in a damaged system that communicates with an operator and performs malicious activity according to the instructions of the operator. The network formed by the bot and a remote command/control server, which functions as the operator to control the actions of the bot and transmit the information needed for the actions of the bot, is collectively referred to as a botnet.

With the occurrence of attacks by such botnets including malicious bots increasing continuously, there is a continued increase in social and economic losses caused by malicious bots. To provide a specific example, the DDoS (Distributed Denial-of-Service) attack by malicious bots in 2009 caused serious losses on a national level. In establishing a plan for countering such attacks by malicious bots, as well as in developing software such as vaccines, etc., for removing malicious bots that damage the system and lower its performance, there is first a need for analyzing the malicious activity of a botnet including malicious bots.

Furthermore, in correspondence with the continued developments in analysis systems for countering botnets including malicious bots and in software such as vaccines, etc., botnets including malicious bots are also evolving, using intelligent analysis avoidance methods such as kernel-level rootkit methods, virtual environment detection methods, DLL or binary file insertion methods, etc., or attacking a system by a method of which there are no analysis results regarding the botnet including malicious bots and which is hence impossible to counter with software such as vaccines, etc., and so on.

In this context, the present invention provides a system that can monitor and analyze malicious activity of botnets including malicious bots in real time.

### SUMMARY

An aspect of the invention is to provide a system that can analyze the activity of a botnet including malicious bots in real time by hooking Windows API calls executed by malicious bots from virtual environments and analyzing the traffic to analyze the commands of the remote command/control server controlling the malicious bots, in order that the social and economic losses which may result from a system attack by a botnet including malicious bots can be prevented in advance.

A system for analyzing malicious botnet activity in real time according to an aspect of the invention includes: a control server configured to generate botnet activity information relating to a type of malicious botnet activity and transmit the botnet activity information to the outside, after receiving bot occurrence information from the outside; and a bot executing server configured to execute a malicious bot corresponding to the bot occurrence information received from the outside in a virtual environment operating system and transmit a real-time botnet detection result to the control server for generating the botnet activity information, according to a control of the control server, wherein the real-time botnet detection result includes information on whether or not the malicious bot performs malicious activity based on a command from a remote command/control server existing independently outside.

Here, the control server may preferably include: a control module configured to control an exchange of information with the outside and control the bot execution server; an event manager module configured to check bot occurrence information stored in a first communication module and transmit a command, according to a control of the control module; a botnet analysis module configured to generate botnet activity information based on a real-time botnet detection result received from the bot executing server and transmit the botnet activity information to the outside by way of the first communication module, according to a control of the control module; a virtual environment manager module configured to transmit a control command such that the bot executing server detects malicious botnet activity based on an execution of a malicious bot, based on a command received from the event manager module; and a first communication module configured to receive and store the bot occurrence information from the outside and transmit the botnet activity information to the outside, according to a control of the control module.

Also, the control server may preferably include an information storage module configured to store the botnet activity information according to a control of the control module.

The bot executing server may preferably include: a bot manager module configured to generate bot file information and execute a kernel driver for detecting malicious activity caused by executing the malicious bot, according to a control of the control server, where the bot file information is generated by receiving from the outside and analyzing the malicious bot corresponding to the bot occurrence information; a bot executing module configured to generate detected-process information, by executing the malicious bot in a virtual environment operating system, according to a control of the bot manager module; an ASM module configured to insert an ASM code for hooking parameter information from a Windows API called by the malicious bot based on the bot file information and the detected-process information, and allowing the bot executing module 320 to re-execute the malicious bot after the ASM code is inserted into the Windows API called by the malicious bot, according to a control of the bot manager module; a monitoring module configured to analyze a result of executing a kernel driver by the bot manager module and transmit a result of analyzing a command received by the malicious bot from a remote command/control server based on parameter information extracted from re-executing the malicious bot in the bot executing module and on a list of Windows API called by the malicious bot; an activity information analysis module configured to generate a real-time botnet detection result by determining whether or not the malicious bot performed malicious activity according to a command from a remote command/control server, based on analysis results received from the monitoring module, and transmit the real-time botnet detection result to the control server; and a second communication module configured to receive a malicious bot from the outside according to a control of the bot manager module and transmit the real-time botnet detection result to the control server according to a control of the activity information analysis module.

According to an aspect of the invention, it is possible to monitor and analyze in real time the activity of botnets including malicious bots. Thus, the social, economic losses that may be caused by malicious bots can be prevented in advance, and furthermore, the monitoring and analysis results can be used in developing software such as vaccines, etc., for defending against attacks made by malicious bots whose malicious activity has been detected, so that the extent of the losses may be reduced.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a diagram showing the overall composition of a system for analyzing malicious botnet activity in real time according to an embodiment of the invention.

FIG. 2a is a diagram for illustrating a control server within a system for analyzing malicious botnet activity in real time according to an embodiment of the invention.

FIG. 2b is a diagram for illustrating a bot executing server within a system for analyzing malicious botnet activity in real time according to an embodiment of the invention.

### DETAILED DESCRIPTION

Before providing the detailed disclosure for practicing embodiments of the invention, it is to be noted that the description of certain elements not directly related to the technical essence of the invention has been omitted within a range that does not obscure the essence of the invention. Also, the terms and words used in the specification and the appended claims are to be interpreted to convey the meaning and concepts that are in keeping with the technical spirit of the invention, under the principle that an inventor may define a term to convey a certain concept in order to best describe the invention.

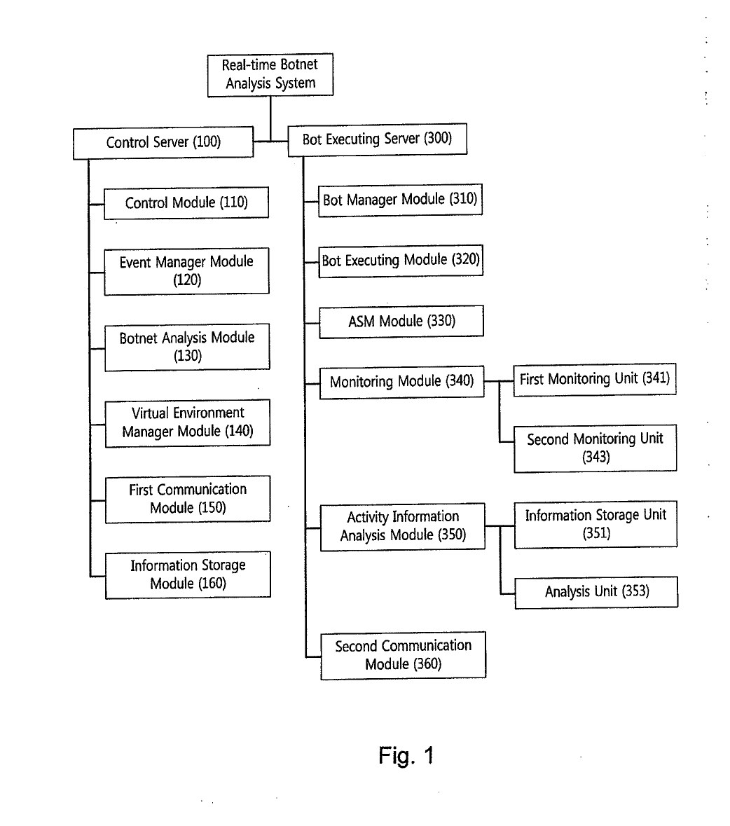

A detailed description will now be provided on the overall composition of a system for analyzing malicious botnet activity in real time according to an embodiment of the invention, with reference to an example illustration appended below. FIG. 1 is a diagram showing the overall composition of a system for analyzing malicious botnet activity in real time according to an embodiment of the invention.

The system for analyzing malicious botnet activity according to an embodiment of the invention may include a control server 100 and a bot executing server 300.

The control server 100 may, after receiving bot occurrence information from the outside, control the bot executing server 300 to generate a real-time botnet detection result, and based on the real-time botnet detection result, may generate botnet activity information, which relates to the type of malicious botnet activity, and transmit the botnet activity information to the outside.

The bot executing server 300, according to the control of the control server 100, may execute a malicious bot, which corresponds to the bot occurrence information received from the outside, in a virtual environment operating system and transmit to the control server 100 a real-time botnet detection result, which relates to whether or not the malicious bot performs malicious activity based on a command from a remote command/control server existing independently outside.

Here, the virtual environment operating system can be an operating system commonly used in personal computers, such as Windows of Microsoft, for example, but is not thus limited and can include any operating system that can be used on the system.

The bot occurrence information may preferably include information regarding whether or not to activate the bot executing server due to a lack of analysis results on a botnet including malicious bots, whether an action of a malicious bot is that of a typical malicious bot or a P2P (peer-to-peer) bot, the name of the malicious bot, the IP address of the remote command/control server controlling the malicious bot, and the MD5 hash value of the malicious bot.

Furthermore, in the system for analyzing malicious botnet activity in real time according to an embodiment of the invention, the control server 100 may receive the bot occurrence information from a botnet control and security management system established independently outside, while the bot executing server 300 may receive a malicious bot corresponding to the bot occurrence information from a malicious bot analysis system established independently outside. The system according to an embodiment of the invention may preferably be linked in a network with the botnet control and security management system and the malicious bot analysis system.

However, the system for analyzing malicious botnet activity in real time according to an embodiment of the invention is not limited to operating in a network with the independently established botnet control and security management system and the malicious bot analysis system described above, and can perform real-time botnet analysis by itself, without being linked to a network, if the bot occurrence information and the malicious bot is received from the outside.

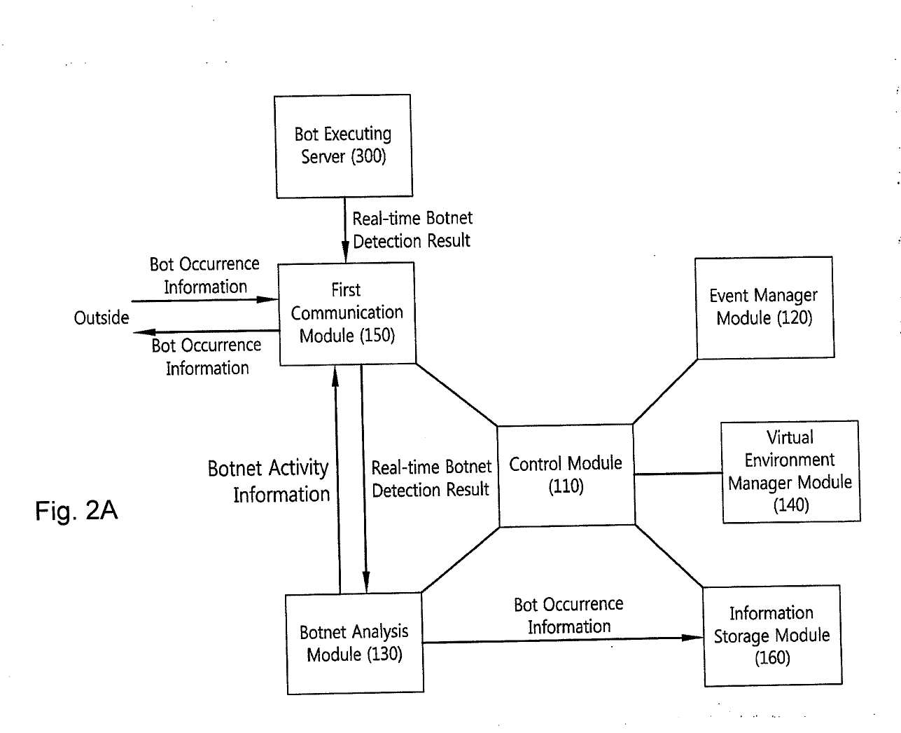

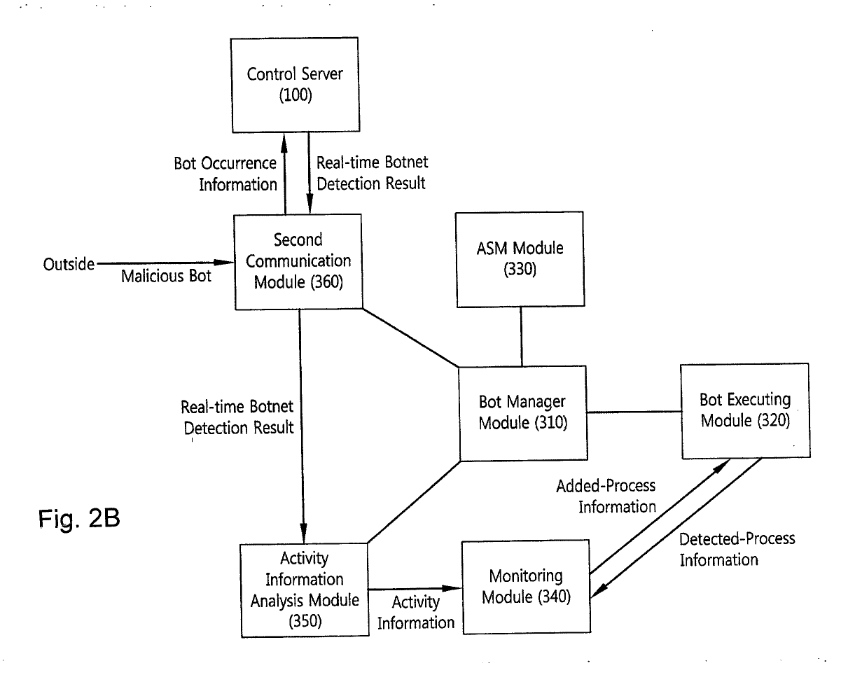

A detailed description will now be provided on the operation of a control server 100 within a system for analyzing malicious botnet activity in real time according to an embodiment of the invention, with reference to an example illustration appended below. FIG. 2a is a diagram for illustrating a control server 100 within a system for analyzing malicious botnet activity in real time according to an embodiment of the invention.

The control server 100 within a system for analyzing malicious botnet activity in real time according to an embodiment of the invention may preferably include a control module 110, an event manager module 120, a botnet analysis module 130, a virtual environment manager module 140, and a first communication module 150, and may further include an information storage module 160.

The control module 110 may control the exchange of information with the outside by way of the first communication module 150 within the control server 100, control the bot execution server 300 by way of the event manager module 120 and the virtual environment manager module 140, and control the botnet analysis module 130 to generate botnet activity information.

To provide a more detailed description, if the control module 110 determines that an operation of the bot executing server 300 is required based on the bot occurrence information received from the outside through the first communication module 150, the control module 110 may control the event manager module 120 to check the bot occurrence information and then control the event manager module 120 to transmit a command to the virtual environment manager module 140 based on the bot occurrence information.

Also, the control module 110 may control the botnet analysis module 130 to generate botnet activity information based on the real-time botnet detection result received from the bot executing server 300.

According to the control of the control module 110, the event manager module 120 may check the bot occurrence information stored in the first communication module 150 and then transmit the command to the virtual environment manager module 140.

To provide a more detailed description, if the control module 110 determines that an operation of the bot executing server 300 is required based on the bot occurrence information, the event manager module 120 may transmit a command to the virtual environment manager module 140 to control the bot executing server 300.

Preferably, the command transmitted by the event manager module 120 to the virtual environment manager module 140 may be one of a malicious bot execute command and a malicious bot stop command, for controlling the execution of the malicious bot at the bot executing server 300 under a virtual environment operating system, and a receive information command and a transmit information command, for controlling the exchange of information between the control server 100 and the bot executing server 300.

Furthermore, the event manager module 120 may preferably store information regarding the type of command transmitted to the virtual environment manager module 140 as event management information.

The botnet analysis module 130 may, according to the control of the control module 110, generate botnet activity information based on the real-time botnet detection result received from the bot executing server 300 and may transmit the botnet activity information to the outside by way of the first communication module 150.

To provide a more detailed description, the botnet analysis module 130 may generate the botnet activity information based on the real-time botnet detection result received from the bot executing server 300.

Preferably, the botnet activity information may be generated with different items for different types of malicious activity by botnets including malicious bots.

For example, if the type of malicious activity incurred by a botnet including malicious bots is the personal information theft type, the botnet activity information may be generated to include a botnet ID for identifying the botnet, the IP address of the upload server through which the malicious bot uploads the personal information, the protocol of the upload server through which the malicious bot uploads the personal information to the botnet, and information regarding the ports within the upload server through which the malicious bot uploads the personal information.

In another example, if the type of malicious activity incurred by a botnet including malicious bots is the spam mail dispatch type, the botnet activity information may be generated to include a botnet ID for identifying the botnet, information on whether the malicious bot dispatches spam directly or through a mail relay server, the IP address of the mail relay server, and the number of spam mail dispatches made by the malicious bot.

Lastly, if the type of malicious activity incurred by a botnet including malicious bots is the DDoS attack type, the botnet activity information may be generated to include a botnet ID for identifying the botnet, the IP addresses of the systems used by the malicious bot for the DDoS attack, information on whether or not the protocol of the DDoS attack corresponds to TCP, UDP, and ICMP, and information related to the ports used for the DDoS attack.

The virtual environment manager module 140 may, based on the command received from the event manager module 120, control the bot executing server 300 to detect an execution of the botnet based on an execution of the malicious bot.

To provide a more detailed description, when the virtual environment manager module 140 receives a malicious bot execute command from the event manager module 120, the virtual environment manager module 140 may preferably transmit a control command that uses a VMWare API to control the bot executing server 300 to execute the malicious bot in the virtual environment operating system.

Also, when the virtual environment manager module 140 receives a malicious bot stop command from the event manager module 120, the virtual environment manager module 140 may preferably transmit a control command that uses a VMWare API to control the bot executing server 300 to stop the execution of the malicious bot in the virtual environment operating system.

When the virtual environment manager module 140 receives a transmit information command from the event manager module 120, the virtual environment manager module 140 may transmit the bot occurrence information to the bot executing server 300 using a VMWare API.

Also, when the virtual environment manager module 140 receives a receive information command from the event manager module 120, the virtual environment manager module 140 may preferably transmit a control command that uses a VMWare API to control the bot executing server 300 to transmit the real-time botnet detection result to the control server 100.

The first communication module 150 may, according to the control of the control module 110, receive the bot occurrence information from the outside and store the bot occurrence information, and may transmit the botnet activity information to the outside.

The information storage module 160 may, according to the control of the control module 110, store the botnet activity information generated at the botnet analysis module 130.

A detailed description will now be provided on the operation of a bot executing server 300 within a system for analyzing malicious botnet activity in real time according to an embodiment of the invention, with reference to an example illustration appended below. FIG. 2b is a diagram for illustrating a bot executing server 300 within a system for analyzing malicious botnet activity in real time according to an embodiment of the invention.

The bot executing server 300 within a system for analyzing malicious botnet activity in real time according to an embodiment of the invention may preferably include a bot manager module 310, a bot executing module 320, an ASM module 330, a monitoring module 340, an activity information analysis module 350, and a second communication module 360.

According to the control of the control server 100, the bot manager module 310 may generate bot file information, which is a result of receiving the malicious bot corresponding to the bot occurrence information from the outside and analyzing the malicious bot, control the bot executing module 320 to execute a malicious bot based on the bot file information, and execute a kernel driver for detecting malicious activity caused by executing the malicious bot.

To provide a more detailed description, the bot manager module 310 may receive a control command from the virtual environment manager module 140 described above that controls the execution of the malicious bot, and also receive the bot occurrence information.

Thus, the bot manager module 310 may receive the malicious bot from the outside through the second communication module 360, based on the MD5 hash value of the corresponding bot included in the bot occurrence information. Then, the bot manager module 310 may generate bot file information as a result of analyzing the file extension of the received malicious bot and the PE(portable executable) file structure, and based on the bot file information, may control the bot executing module 320 to execute the malicious bot.

Here, the bot file information may include, at least, the file extension of the malicious bot, the time at which the malicious bot was registered in the bot executing server 300, the PE file structure, and the file execution path of the malicious bot.

Also, the bot manager module 310 may execute a kernel driver for detecting the malicious activity caused by executing the malicious bot, where the kernel driver may include a registry event monitoring kernel driver, a file event monitoring kernel driver, a memory event monitoring kernel driver, a network event monitoring kernel driver, and an SSDT virtualization kernel driver.

The bot executing module 320 may, according to the control of the bot manager module 310, generate detected-process information, by executing the malicious bot in a virtual environment operating system, and may re-execute the malicious bot after the ASM module 330 inserts an ASM code into a Windows API called by the malicious bot.

Preferably, the bot executing module 320 may further include a function of updating the detected-process information based on added-process information received from the monitoring module 340.

To provide a more detailed description, if the PE file format of the malicious bot is a Win32 execution file, the bot executing module 320 may, according to the control of the bot manager module 310, execute the malicious bot in suspend mode in the virtual environment operating system, and afterwards extract the process ID and process handler of the process executed by the malicious bot and generate detected-process information, including the PEB (process environmental block) address, EPROCESS address, process starting time, etc., based on the process ID and process handler.

Also, if the PE file format of the malicious bot is a DLL file, the bot executing module 320 may execute a dummy process in suspend mode in the virtual environment operating system, and afterwards insert the malicious bot in the dummy process, extract the process ID and process handler of the dummy process to which the malicious bot has been inserted, and generate detected-process information, including the PEB address, EPROCESS address, process starting time, etc., based on the process ID and process handler.

In addition, after the ASM module 330, which will be described later in further detail, inserts an ASM code into the Windows API (application programming interface) called by the malicious bot, the bot executing module 320 may re-execute the malicious bot, and as the malicious bot is re-executed, parameter information may be extracted due to the ASM code inserted in the Windows API.

The ASM module 330 may, according to the control of the bot manager module 310, insert the ASM code into the Windows API called by the malicious bot, based on the bot file information and the detected-process information.

To provide a more detailed description, the ASM module 330 may check the detected-process information generated at the bot executing module 320 by the execution of the malicious bot, based on the MD5 hash value of the malicious bot included in the bot file information.

Then, the ASM module 330 may extract the DLL file list imported by the malicious bot in the virtual environment operating system, and extract a list of the Windows API's being exported by the DLL files imported by the malicious bot.

Thus, the ASM module 330 may insert an ASM code for hooking the parameter information into the Windows API's being exported by the DLL file imported by the malicious bot, based on the extracted list of Windows API's, and as described above, the inserted ASM code may extract the parameter information of the Windows API's exported according to the execution of the malicious bot.

The monitoring module 340 may analyze the result of executing the kernel driver by the bot manager module 310 and may transmit the result of analyzing the command received by the malicious bot from a remote command/control server, based on the parameter information extracted from re-executing the malicious bot in the bot executing module 320 and on the list of Windows API's called by the malicious bot, to the activity information analysis module 350.

Preferably, the monitoring module 340 may include a first monitoring unit 341 that generates first activity information by analyzing the command received by the malicious bot from the remote command/control server based on the parameter information and the list of Windows API's called by the malicious bot, and transmits the first activity information to the activity information analysis module 350; and a second monitoring unit 343 that generates second activity information by analyzing the activity performed by the malicious bot using a kernel driver in the virtual environment operating system without calling Windows API's, and transmits the second activity information to the activity information analysis module 350.

In addition, the second monitoring unit 343 may preferably further include a function of generating added-process information based on the second activity information and transmitting the added-process information to the bot executing module 320.

To provide a more detailed description on the first monitoring unit 341, when the malicious bot is executed by calling a Windows API to which the ASM code has been inserted, the parameter information of the Windows API required for executing the malicious bot may be extracted due to the ASM code as described above, and the first monitoring unit 341 may, based on the detected-process information and the parameter information described above, extract received-data information, which is the information received by the malicious bot for performing malicious activity from the remote command/control server that controls the malicious bot.

Here, the received-data information may preferably include one or more of IP information of the target of the malicious bot, information regarding the address at which the data received by the malicious bot from the remote command/control server is stored, and information regarding the data received by the malicious bot from the remote command/control server.

Preferably, the information regarding the data received by the malicious bot from the remote command/control server may include the spam template and the receiver mail addresses of the targets of the span dispatch, if the object of the malicious activity of the malicious bot is to dispatch spam, the server to which the personal information will be uploaded and the ports of the server, if the object of the malicious activity of the malicious bot is to steal personal information, and the type of protocol used for the attack and the ports, etc., used for the attack, if the object of the malicious activity of the malicious bot is to incur a DDoS attack.

Thus, the first monitoring unit 341 may generate the first activity information to include the detected-process information, the information regarding the list of Windows API's called by the malicious bot, and the received-data information, and may transmit the first activity information to the activity information analysis module 350.

To provide a more detailed description on the second monitoring unit 343, in addition to the function of monitoring the actions executed by the malicious bot without calling a Windows API at a kernel level in the virtual environment operating system using a kernel driver, the second monitoring unit 343 may preferably further include a function of generating added-process information, which is information regarding the processes generated as the malicious bot is executed in the virtual environment operating system at a kernel level, and transmitting the added-process information to the bot executing module 320 to update the detected-process information.

Here, the second monitoring unit 343 may preferably monitor whether or not the malicious bot modifies the registry in the virtual environment operating system, by way of the registry event monitoring kernel driver, whether or not the malicious bot modifies files in the virtual environment operating system, by way of the file event monitoring kernel driver, whether or not there are changes in the data stored in the memory caused by an action of the malicious bot, by way of the memory event monitoring kernel driver, whether or not the malicious bot receives information from a remote command/control server, by way of the network event monitoring kernel driver, and whether or not the malicious bot performs an activity for calling a Windows API at a kernel level, by way of the SSDT virtualization kernel driver.

Thus, the second monitoring unit 343 may generate second activity information, as the monitoring results obtained by way of the kernel driver of the actions executed by the malicious bot at a kernel level in the virtual environment operating system without calling a Windows API, and may transmit the second activity information to the activity information analysis module 350.

Here, the second activity information may preferably include, at least, information regarding the address at which the data received from a remote command/control server by the malicious bot at a kernel level in the virtual environment operating system without calling a Windows API is stored, and the IP addresses of the targets of the malicious bot's attacks, etc.

Also, the second monitoring unit 343 may preferably generate added-process information, as information on the processes that are generated during the execution of the malicious bot at a kernel level in the virtual environment operating system, and transmit the added-process information to the bot executing module 320, while the bot executing module 320 may update the detected-process information based on the added-process information received from the second monitoring unit 343.

Here, the added-process information may include, at least, the process ID's, process handlers, and PEB (process environmental block) addresses of the processes generated during the execution of the malicious bot at a kernel level in the virtual environment operating system.

Based on the analysis results received from the monitoring module 340, the activity information analysis module 350 may determine whether or not the malicious bot performed malicious activity according to a command received from a remote command/control server, to generate a real-time botnet detection result, and transmit the real-time botnet detection result to the control server 100.

The activity information analysis module 350 may preferably include an information storage unit 351 that receives the first activity information and stores the first activity information in a database; and an analysis unit 353 that determines whether or not the malicious bot performs malicious activity according to a command from a remote command/control server existing independently outside and whether or not the malicious activity corresponds to a pre-classified type of malicious activity, based on the database stored in the information storage unit 351 and the second activity information, and if the determining indicates that the malicious activity corresponds to a pre-classified type, generates a real-time botnet detection result and transmits the real-time botnet detection result to the control server 100 by way of the second communication module 360.

To provide a more detailed description of the information storage unit 351, the information storage unit 351 may receive the first activity information described above from the first monitoring unit 341 and store the first activity information in a database.

To provide a more detailed description of the analysis unit 353, analyzing whether or not the activity of a botnet including malicious bots corresponds to a pre-classified type of malicious activity may first include determining whether or not the malicious bot calls a Windows API based on the received-data information. If, as a result, it is determined that the malicious bot calls a Windows API based on the received-data information, then it may be determined that the malicious bot performs the malicious activity according to a command received from the remote command/control server, and then, using a network packet filter driver, it may be analyzed whether or not the traffic transmitted by the malicious bot outside the bot executing server 300 corresponds to a pre-classified type of malicious activity.

Thus, the analysis unit 353 may filter those cases in which the malicious bot does not perform malicious activity based on a command received from the remote command/control server and exclude these cases from the real-time botnet detection result. However, for those cases in which it is determined that the malicious bot does perform malicious activity based on a command received from the remote command/control server, the real-time botnet detection result may be generated, which is the analysis result according to the pre-classified malicious activity type, and transmitted to the control server 100 by way of the second communication module 360.

Here, the pre-classified type of malicious activity may preferably be a DDoS attack type, a spam mail dispatch type, and a personal information theft type.

However, the type of malicious activity that can be analyzed by the system for analyzing malicious botnet activity in real time according to an embodiment of the invention is not limited to those described above, and all types of malicious activity caused by a bot net including malicious bots and a remote command/control server controlling the malicious bots can be analyzed.

Also, the real-time botnet detection result may preferably be generated with different items for different types of malicious activity as described above.

For example, if the pre-classified type of malicious activity is the personal information theft type, the real-time botnet detection result may be generated to include information regarding the list of Windows API's called by the malicious bot, a botnet ID for identifying the botnet, the IP address of the upload server through which the malicious bot uploads the personal information, the protocol of the upload server through which the malicious bot uploads the personal information to the botnet, and information regarding the ports within the upload server through which the malicious bot uploads the personal information.

In another example, if the pre-classified type of malicious activity is the spam mail dispatch type, the real-time botnet detection result may be generated to include information regarding the list of Windows API's called by the malicious bot, a botnet ID for identifying the botnet, information on whether the malicious bot dispatches spam directly or through a mail relay server, the IP address of the mail relay server, and the number of spam mail dispatches made by the malicious bot.

Lastly, if the pre-classified type of malicious activity is the DDoS attack type, the real-time botnet detection result may be generated to include information regarding the list of Windows API's called by the malicious bot, a botnet ID for identifying the botnet, the IP addresses of the systems used by the malicious bot for the DDoS attack, information on whether or not the protocol of the DDoS attack corresponds to TCP, UDP, and ICMP, and information related to the ports used for the DDoS attack.

The second communication module 360 may receive the malicious bot from the outside according to the control of the bot manager module 310, and transmit the real-time botnet detection result to the control server 100 according to the control of the activity information analysis module 350.

While the foregoing descriptions and illustrations have been provided with reference to preferred embodiments used as an example for conveying the spirit of the invention, the invention is not limited to the compositions and operations disclosed in the descriptions and drawings. Moreover, the skilled person will readily understand that various changes and modifications can be made without departing from the scope and spirit of the invention. As such, embodiments of the invention to which suitable changes and modifications have been made, as well as various equivalents of the invention, are to be considered to be within the scope of the present invention.

1. A system for analyzing malicious botnet activity in real time, the system comprising:
a control server 100 configured to generate botnet activity information relating to a type of malicious botnet activity and transmit the botnet activity information to the outside, after receiving bot occurrence information from the outside; and
a bot executing server 300 configured to execute a malicious bot corresponding to the bot occurrence information received from the outside in a virtual environment operating system and transmit a real-time botnet detection result to the control server 100 for generating the botnet activity information, according to a control of the control server 100, wherein the real-time botnet detection result includes information on whether or not the malicious bot performs malicious activity based on a command from a remote command/control server existing independently outside.

2. The system according to claim 1, wherein the control server 100 comprises:
a control module 110 configured to control the bot executing server 300 and control an exchange of information with the outside;
an event manager module 120 configured to check bot occurrence information stored in a first communication module 150 and transmit a command, according to a control of the control module 110;
a botnet analysis module 130 configured to generate botnet activity information based on a real-time botnet detection result received from the bot executing server 300 and transmit the botnet activity information to the outside by way of the first communication module 150, according to a control of the control module 110;
a virtual environment manager module 140 configured to transmit a control command such that the bot executing server 300 detects malicious botnet activity based on an execution of a malicious bot, based on a command received from the event manager module 120; and
a first communication module 150 configured to receive and store the bot occurrence information from the outside and transmit the botnet activity information to the outside, according to a control of the control module 110.

3. The system according to claim 2, wherein the control server 100 further comprises:
an information storage module 160 configured to store the botnet activity information according to a control of the control module 110.

4. The system according to claim 1 any one of claim 1 through claim 3, wherein the bot executing server 300 comprises:
a bot manager module 310 configured to generate bot file information and execute a kernel driver for detecting malicious activity caused by executing the malicious bot, according to a control of the control server 100, wherein the bot file information is generated by receiving from the outside and analyzing the malicious bot corresponding to the bot occurrence information;
a bot executing module 320 configured to generate detected-process information, by executing the malicious bot in a virtual environment operating system, according to a control of the bot manager module 310;
an ASM module 330 configured to insert an ASM code for hooking parameter information from a Windows API called by the malicious bot based on the bot file information and the detected-process information, and allowing the bot executing module 320 to re-execute the malicious bot after the ASM code is inserted into the Windows API called by the malicious bot, according to a control of the bot manager module 310;
a monitoring module 340 configured to analyze a result of executing a kernel driver by the bot manager module 310 and transmit a result of analyzing a command received by the malicious bot from a remote command/control server based on parameter information extracted from re-executing the malicious bot in the bot executing module 320 and on a list of Windows API called by the malicious bot;
an activity information analysis module 350 configured to generate a real-time botnet detection result by determining whether or not the malicious bot performed malicious activity according to a command from a remote command/control server, based on analysis results received from the monitoring module 340, and transmit the real-time botnet detection result to the control server 100; and
a second communication module 360 configured to receive a malicious bot from the outside according to a control of the bot manager module 310 and transmit the real-time botnet detection result to the control server 100 according to a control of the activity information analysis module 350.

5. The system according to claim 4, wherein the monitoring module 340 comprises:
a first monitoring unit 341 configured to generate first activity information by analyzing a command received by the malicious bot from the remote command/control server existing independently outside, based on the parameter information and a list of Windows API called by the malicious bot, and transmit the first activity information to the activity information analysis module 350; and
a second monitoring unit 343 configured to generate second activity information by analyzing activity performed by the malicious bot at a kernel level within a virtual environment operating system without a Windows API call, and transmit the second activity information to the activity information analysis module 350.

6. The system according to claim 5, wherein the second monitoring unit 343 further includes a function of generating added-process information based on the second activity information and transmitting the added-process information to the bot executing module 320.

7. The system according to claim 6, wherein the bot executing module 320 further includes a function of updating the detected-process information based on the added-process information received from the monitoring module 340.

8. The system according to claim 5, wherein the activity information analysis module 350 comprises:
an information storage unit 351 configured to receive the first activity information and store the first activity information in a database; and
an analysis unit 353 configured to determine whether or not the malicious bot performs malicious activity according to a command from a remote command/control server existing independently outside and whether or not the malicious activity corresponds to a pre-classified type of malicious activity, based on the database stored in the information storage unit 351 and the second activity information, and if the determining indicates that the malicious activity corresponds to the pre-classified type, generate a real-time botnet detection result and transmit the real-time botnet detection result to the control server 100 by way of the second communication module 360.

9. The system according to claim 8, wherein the pre-classified type of malicious activity is any one of a DDoS attack type, a spam mail dispatch type, and a personal information theft type.
